(19) United States
(12) Patent Application Publication
(10) Pub. No.: US 2026/0277441 A1
(43) Pub. Date: Sep. 17, 2026

(54) DATA DEFRAGMENTATION METHOD AND DATA STORAGE SYSTEM

(71) Applicant: Hefei Kaimeng Technology Co., Ltd., Anhui (CN)

(72) Inventors: Lin CHEN, Anhui (CN); Tsung-Lin Wu, Anhui (CN); Qiao ZHU, Anhui (CN); Zhi WANG, Anhui (CN); Fan HU, Anhui (CN); Dongsheng GUAN, Anhui (CN)

(73) Assignee: Hefei Kaimeng Technology Co., Ltd., Anhui (CN)

(21) Appl. No.: 19/669,901

(22) Filed: May 6, 2026

(30) Foreign Application Priority Data
May 26, 2025 (CN) 202510684667.6

(51) Int. Cl. G06F 3/06

(52) U.S. Cl. CPC G06F 3/0611; G06F 3/0659; G06F 3/0679

(57) ABSTRACT

A data defragmentation method and a data storage system are provided. The method includes: determining a plurality of candidate logical regions among a plurality of logical regions according to access hotness information, where the access hotness information reflects host access hotness corresponding to the logical regions, determining a first logical region among the candidate logical regions as a target logical region according to response time information after determining the candidate logical regions, where the response time information reflects storage device response time corresponding to the candidate logical regions; and instructing the storage device to perform defragmentation on target data belonging to the target logical region.

### CROSS-REFERENCE TO RELATED APPLICATION

This application claims the priority benefit of China application serial no. 202510684667.6, filed on May 26, 2025. The entirety of the above-mentioned patent application is hereby incorporated by reference herein and made a part of this specification.

### BACKGROUND

### Technical Field

The disclosure relates to a storage technology field, and more particularly, to a data defragmentation method and a data storage system.

### Description of Related Art

During the use of storage products, with continuous write, delete, and read operations, as well as the limitations of the characteristics of flash memory media itself, fragmentation is inevitably generated, resulting in logically contiguous but physically non-contiguous data. Data read performance is thus reduced, and the user experience is thereby affected. At present, common defragmentation mechanisms include the host specifying a logical range for defragmentation, or the storage controller itself selecting storage blocks storing less valid data for defragmentation. However, neither of the above methods can perform defragmentation on data frequently read by the host system. Therefore, even after multiple times of defragmentation, most of the time, users still feel that the operational performance of the storage device continues to be low.

### SUMMARY

The disclosure provides a data defragmentation method and a data storage system capable of improving the above problems, so that the operational performance of the storage device is improved.

An embodiment of the disclosure provides a data defragmentation method for a host system connected to a storage device including a memory module. The data defragmentation method includes the following steps. A plurality of candidate logical regions among a plurality of logical regions are determined according to access hotness information. The access hotness information reflects host access hotness corresponding to the logical regions, and the total number of the candidate logical regions is less than the total number of the logical regions. A first logical region among the candidate logical regions is determined as a target logical region according to response time information after the candidate logical regions are determined. The response time information reflects storage device response time corresponding to the candidate logical regions. The storage device is instructed to perform defragmentation on target data belonging to the target logical region.

An embodiment of the disclosure further provides a data storage system including a storage device and a host system. The host system is connected to the storage device. The storage device includes a memory module. The host system is configured to determine a plurality of candidate logical regions among a plurality of logical regions according to access hotness information, where the access hotness information reflects host access hotness corresponding to the logical regions, and the total number of the candidate logical regions is less than the total number of the logical regions, determine a first logical region among the candidate logical regions as a target logical region according to response time information after the candidate logical regions are determined, where the response time information reflects storage device response time corresponding to the candidate logical regions, and instruct the storage device to perform defragmentation on target data belonging to the target logical region.

### BRIEF DESCRIPTION OF THE DRAWINGS

FIG. 1 is a schematic view illustrating a data storage system according to an embodiment of the disclosure.

FIG. 2 is a schematic view illustrating a memory controller according to an embodiment of the disclosure.

FIG. 3 is a schematic view illustrating management of a memory module according to an embodiment of the disclosure.

FIG. 4 is a schematic view illustrating division of a plurality of logical regions according to an embodiment of the disclosure.

FIG. 5 is a schematic view illustrating determination a target logical region based on host access hotness and storage device response time according to an embodiment of the disclosure.

FIG. 6 is a flow chart illustrating a data defragmentation method according to an embodiment of the disclosure.

### DESCRIPTION OF THE EMBODIMENTS

Descriptions of the disclosure are given with reference to the exemplary embodiments illustrated by the accompanying drawings. Wherever possible, the same reference numbers are used in the drawings and the description to refer to the same or like parts.

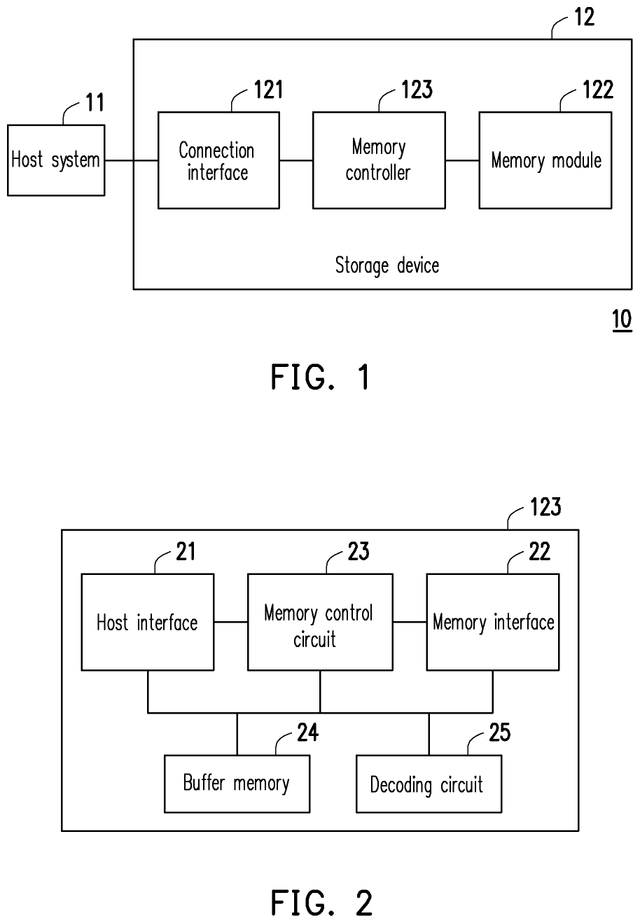

FIG. 1 is a schematic view illustrating a data storage system according to an embodiment of the disclosure. Referring to FIG. 1, a data storage system 10 includes a host system 11 and a storage device 12. The storage device 12 may be connected to the host system 11 and may be used to store data from the host system 11. For instance, the host system 11 may be a smartphone, a tablet computer, a notebook computer, a desktop computer, an industrial computer, a gaming console, a server, or a computer system disposed in a specific carrier (e.g., a vehicle, an aircraft, or a ship), and a type of the host system 11 is not limited thereto. In addition, the storage device 12 may include a solid-state drive, a USB flash drive, a memory card, or other types of non-volatile storage devices.

The storage device 12 includes a connection interface 121, a memory module 122, and a memory controller 123. The connection interface 121 is used to connect the storage device 12 to the host system 11. For instance, the connection interface 121 may support the embedded multi-media card (eMMC), universal flash storage (UFS), peripheral component interconnect express (PCI Express), non-volatile memory express (NVM express), serial advanced technology attachment (SATA), universal serial bus (USB), or other types of connection interface standards. Therefore, the storage device 12 may communicate (e.g., exchange signals, instructions, and/or data) with the host system 11 via the connection interface 121.

The memory module 122 is used to store data. For instance, the memory module 122 may include one or more rewritable non-volatile memory modules. Each rewritable non-volatile memory module may include one or more storage unit arrays. Storage units in the storage unit arrays store data in the form of voltage (also referred to as threshold voltage). For instance, the memory module 122 may include a single level cell (SLC) NAND flash memory module, a multi level cell (MLC) NAND flash memory module, a triple level cell (TLC) NAND flash memory module, a quad level cell (QLC) NAND flash memory module, and/or other memory modules having the same or similar characteristics.

The memory controller 123 is connected to the connection interface 121 and the memory module 122. The memory controller 123 may be treated as a control core of the storage device 12 and is used to control the storage device 12. For instance, the memory controller 123 may be used to control or manage the overall operation or partial operations of the storage device 12. For instance, the memory controller 123 may include a central processing unit (CPU), or other programmable general-purpose or special-purpose microprocessor, digital signal processor (DSP), programmable controller, application specific integrated circuit (ASIC), programmable logic device (PLD), or other similar devices or combinations of these devices. In an embodiment, the memory controller 123 may include a flash memory controller.

The memory controller 123 may send an instruction sequence to the memory module 122 to access the memory module 122. For instance, the memory controller 123 may send a write instruction sequence to the memory module 122, so as to instruct the memory module 122 to store data in a specific storage unit. For instance, the memory controller 123 may send a read instruction sequence to the memory module 122, so as to instruct the memory module 122 to read data from a specific storage unit. For instance, the memory controller 123 may send an erase instruction sequence to the memory module 122, so as to instruct the memory module 122 to erase data stored in a specific storage unit. In addition, the memory controller 123 may also send other types of instruction sequences to the memory module 122, so as to instruct the memory module 122 to execute other types of operations, which is not particularly limited by the disclosure. The memory module 122 may receive an instruction sequence from the memory controller 123 and access a storage unit inside the memory module 122 according to the instruction sequence.

FIG. 2 is a schematic view illustrating a memory controller according to an embodiment of the disclosure. Referring to FIG. 1 and FIG. 2, the memory controller 123 includes a host interface 21, a memory interface 22, and a memory control circuit 23. The host interface 21 is configured to be connected to the host system 11 through the connection interface 121 to communicate with the host system 11. The memory interface 22 is configured to be connected to the memory module 122 to access the memory module 122.

The memory control circuit 23 is connected to the host interface 21 and the memory interface 22. The memory control circuit 23 may be used to control or manage the overall operation or partial operations of the memory controller 123. For instance, the memory control circuit 23 may communicate with the host system 11 through the host interface 21 and access the memory module 122 through the memory interface 22. For instance, the memory control circuit 23 may include control circuits such as an embedded controller or a microcontroller. In the following embodiments, the description of the memory control circuit 23 is equivalent to the description of the memory controller 123.

In an embodiment, the memory controller 123 may further include a buffer memory 24. The buffer memory 24 is connected to the memory control circuit 23 and is used to buffer data. For instance, the buffer memory 24 may be used to buffer an instruction from the host system 11, data from the host system 11, and/or data from the memory module 122.

In an embodiment, the memory controller 123 may further include a decoding circuit 25. The decoding circuit 25 is connected to the memory control circuit 23 and is used to execute encoding and decoding on data to ensure correctness of the data. For instance, the decoding circuit 25 may support various encoding/decoding algorithms such as the low density parity check code (LDPC code), BCH code, Reed-solomon code (RS code), exclusive OR (XOR) code, and the like. In an embodiment, the memory controller 123 may further include other types of various circuit modules (e.g., a power management circuit, etc.), which is not particularly limited by the disclosure.

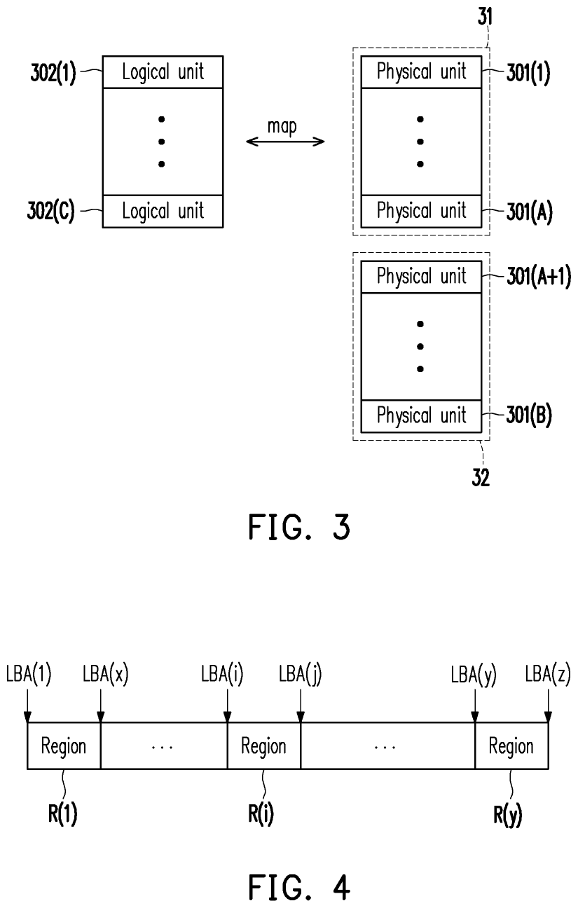

FIG. 3 is a schematic view illustrating management of a memory module according to an embodiment of the disclosure. Referring to FIG. 1 to FIG. 3, the memory module 122 includes a plurality of physical units 301(1) to 301(B). Each physical unit includes a plurality of storage units and is used to non-volatilely store data.

In an embodiment, one physical unit may include one physical programming unit. For instance, a physical programming unit is also referred to as a physical program unit. In an embodiment, one physical erase unit may include a plurality of physical programming units. For instance, one physical erase unit may be treated as one physical block.

In an embodiment, one physical programming unit may include a plurality of physical sectors. For instance, a data capacity of one physical sector may be 512 bytes (B), and one physical programming unit may include 32 physical sectors. However, the data capacity of one physical sector and/or the total number of physical sectors included in one physical programming unit may be adjusted according to practical needs, which is not particularly limited by the disclosure. In an embodiment, one physical programming unit may be treated as one physical page. For instance, the storage capacity of one physical programming unit may be 16 kilobytes, and the disclosure is not limited thereto.

In an embodiment, one physical programming unit is a minimum unit for synchronously writing data in the memory module 122. For instance, when performing a programming operation (also referred to as a write operation) on one physical programming unit to write data to the physical programming unit, multiple storage units in the physical programming unit may be synchronously programmed to store corresponding data. For instance, when programming one physical programming unit, a write voltage may be applied to the physical programming unit, so as to change threshold voltages of at least some storage units in the physical programming unit. For instance, the threshold voltage of one storage unit may reflect bit data stored by the storage unit.

In an embodiment, multiple physical programming units in one physical erase unit may be synchronously erased. For instance, when performing an erase operation on one physical erase unit, an erase voltage may be applied to the multiple physical programming units in this physical erase unit, so as to change the threshold voltages of at least some storage units in these physical programming units. By performing an erase operation on one physical erase unit, data stored in this physical erase unit may be cleared.

In an embodiment, the memory control circuit 23 may logically associate the physical units 301(1) to 301(A) and 301(A+1) to 301(B) to a data zone 31 and a free zone 32, respectively. The physical units 301(1) to 301(A) in the data zone 31 all store data (also referred to as user data) from the host system 11. For instance, any physical unit in the data zone 31 may store valid data and/or invalid data. In addition, the physical units 301(A+1) to 301(B) in the free zone 32 do not store data (e.g., valid data).

In an embodiment, if a specific physical unit does not store valid data, this physical unit may be associated with the free zone 32. In addition, the physical unit in the free zone 32 may be erased to clear the data in this physical unit. In an embodiment, the physical unit in the free zone 32 is also referred to as a free physical unit. In an embodiment, the free zone 32 is also referred to as a free pool.

In an embodiment, when data is to be stored, the memory control circuit 23 may select one or more physical units from the free zone 32 and instruct the memory module 122 to store the data in the selected physical unit. After storing the data in the physical unit, the physical unit may be associated with the data zone 31. In other words, one or more physical units may be alternately used between the data zone 31 and the free zone 32.

In an embodiment, the memory control circuit 23 may be provided with a plurality of logical units 302(1) to 302(C) to map physical units (i.e., physical units 301(1) to 301(A)) in the data zone 31. For instance, one logical unit may correspond to one logical block address (LBA) or other logical management units. One logical unit may map to one or more physical units.

In an embodiment, if a specific physical unit is currently mapped by any logical unit, the memory control circuit 23 may determine that the data currently stored in this physical unit includes valid data. Conversely, if a specific physical unit is currently not mapped by any logical unit, the memory control circuit 23 may determine that this physical unit currently does not store any valid data.

In an embodiment, the memory control circuit 23 may record a mapping relationship between logical units and physical units in at least one management table (also referred to as a logical-to-physical mapping table). In an embodiment, the memory control circuit 23 may instruct the memory module 122 to execute operations such as data read, write, or erase according to information in this management table (i.e., the logical-to-physical mapping table).

In the following embodiments, the operations performed by the host system 11 may be treated as being performed by the processor of the host system 11. For instance, the processor of the host system 11 may include a central processing unit (CPU), or other programmable general-purpose or special-purpose microprocessors, a digital signal processor (DSP), a programmable controller, an application-specific integrated circuit (ASIC), a programmable logic device (PLD), other similar devices, or a combination of these devices.

FIG. 4 is a schematic view illustrating division of a plurality of logical regions according to an embodiment of the disclosure. Referring to FIG. 4, in an embodiment, the host system 11 may divide a plurality of regions (also referred to as logical regions) R(1) to R(y) from logical addresses LBA(1) to LBA(z). For instance, the region R(1) may cover the logical addresses LBA(1) to LBA(x), the region R(i) may cover the logical addresses LBA(i) to LBA(j), and the region R(y) may cover the logical addresses LBA(y) to LBA(z). Each of the logical addresses LBA(1) to LBA(z) may correspond to one of the logical units 302(1) to 302(C) of FIG. 3. Each of the regions R(1) to R(y) may include a plurality of consecutive logical units. In addition, the logical addresses LBA(1) to LBA(z) may cover all or at least part of the logical addresses (or logical units) accessible by the host system 11.

In an embodiment, the total number of logical units included in each of the regions R(1) to R(y) is fixed and/or the same. For instance, each of the regions R(1) to R(y) may include 1024 consecutive logical units. In an embodiment, the total number of logical units included in each of the regions R(1) to R(y) may also be non-fixed and/or dynamically adjustable. In an embodiment, the total numbers of logical units included in any two of the regions R(1) to R(y) may be different as well. In other words, the total number of logical units included in each region may also be adjusted according to practical needs, which is not limited by the disclosure.

In an embodiment, the host system 11 may monitor an access behavior (or accessing behavior) of the host system 11 to the storage device 12, so as to obtain access hotness information. The access hotness information may reflect host access hotness corresponding to the divided plurality of logical regions (e.g., regions R(1) to R(y)).

It should be noted that in the following embodiments, the region R(i) among the regions R(1) to R(y) will be used as an example for illustration. In addition, the following description regarding the region R(i) may also be applied to any one of the regions R(1) to R(y).

In an embodiment, the host access hotness corresponding to the region R(i) may reflect a frequency at which the logical units located in the region R(i) are accessed by the host system 11. For instance, if the host access hotness corresponding to the region R(i) is higher, it indicates that the logical units located in the region R(i) are accessed by the host system 11 at a higher frequency.

In an embodiment, the host system 11 may obtain a count information (also referred to as first count information) according to the access behavior. The first count information may reflect the number of host accesses to the region R(i) (also referred to as the first number of host accesses) within a certain time frame (also referred to as the first time frame). For instance, within the first time frame, whenever the host system 11 accesses a logical unit located in the region R(i) once (e.g., the host system 11 reads data belonging to this logical unit), the host system 11 may add “1” to the first count information to update the first count information. The updated first count information may reflect the first number of host accesses.

In an embodiment, the host system 11 may obtain another count information (also referred to as second count information) according to the access behavior. The second count information may reflect the number of host accesses to the region R(i) (also referred to as the second number of host accesses) within another time frame (also referred to as the second time frame). For instance, the second time frame is ordered after the first time frame in time, and a time length of the first time frame is the same as a time length of the second time frame. For instance, within the second time frame, whenever the host system 11 accesses a logical unit located in the region R(i) once (e.g., the host system 11 reads data belonging to this logical unit), the host system 11 may add “1” to the second count information to update the second count information. The updated second count information may reflect the second number of host accesses.

In an embodiment, if the second count information is greater than the first count information, it indicates that as time progresses, the host access hotness corresponding to the region R(i) gradually increases. In an embodiment, if the second count information is equal to the first count information, it indicates that as time progresses, the host access hotness corresponding to region R(i) remains unchanged. Alternatively, in an embodiment, if the second count information is less than the first count information, it indicates that as time progresses, the host access hotness corresponding to the region R(i) decreases.

In an embodiment, the host system 11 may obtain the access hotness information corresponding to the region R(i) according to the first count information and the second count information. For instance, the host system 11 may subtract the first count information from the second count information to obtain a difference value between the first count information and the second count information. For instance, this difference value may be used to reflect the change (or change trend) of the host access hotness corresponding to the region R(i) as time progresses. Next, the host system 11 may obtain the access hotness information corresponding to the region R(i) according to this difference.

In an embodiment, the access hotness information corresponding to the region R(i) may include an evaluation value (also referred to as a hotness evaluation value). For instance, the hotness evaluation value may be positively correlated with the host access hotness corresponding to the region R(i). That is, if the hotness evaluation value is greater, it indicates that the host access hotness corresponding to the region R(i) is higher. In an embodiment, the host system 11 may input the difference value between the first count information and the second count information into a predetermined algorithm or use the difference value to look up a table, so as to obtain the hotness evaluation value.

In an embodiment, after the access hotness information is obtained, the host system 11 may determine a plurality of candidate logical regions among the regions R(1) to R(y) according to the access hotness information. It should be noted that the total number of the candidate logical regions must be less than the total number of the regions R(1) to R(y). That is, in the process of determining the candidate logical regions among the regions R(1) to R(y), a portion of the logical regions among the regions R(1) to R(y) will be selected as candidate logical regions, while another portion of the logical regions among the regions R(1) to R(y) will be excluded from the candidate logical regions.

In an embodiment, the host access hotness corresponding to each logical region among the candidate logical regions is higher than the host access hotness corresponding to the remaining logical regions among the logical regions that do not belong to the candidate logical regions. For instance, assuming that the region R(i) is determined as a candidate logical region, while the region R(y) does not belong to the candidate logical regions, the host access hotness corresponding to the region R(i) is higher than the host access hotness corresponding to the region R(y).

In an embodiment, the host system 11 may determine the host access hotness corresponding to each region among the regions R(1) to R(y) according to the access hotness information. Next, the host system 11 may sort the regions R(1) to R(y) from high to low or from low to high based on the host access hotness. In an embodiment, assuming that the regions ranked higher correspond to higher host access hotness, the host system 11 may select a plurality of regions ranked relatively higher from the sorted regions R(1) to R(y) as the candidate logical regions. Alternatively, in an embodiment, assuming that the regions ranked lower correspond to higher host access hotness, the host system 11 may select a plurality of regions ranked relatively lower from the sorted regions R(1) to R(y) as the candidate logical regions.

In an embodiment, after the candidate logical regions are determined, the host system 11 may determine at least one logical region (also referred to as a first logical region) among the candidate logical regions as a target logical region according to response time information. For instance, the first logical region may include the region R(i). The response time information may reflect storage device response time corresponding to the candidate logical regions.

In an embodiment, when the host system 11 sends a read command to the storage device 12 to instruct accessing a logical unit located in the region R(i) (e.g., reading data from this logical unit), the host system 11 may monitor the processing time or response time of the storage device 12 for the read command. Next, the host system 11 may determine the storage device response time corresponding to the region R(i) according to the processing time or response time of the storage device 12 for the read command. For instance, the processing time or response time of the storage device 12 for the read command may be positively correlated with the storage device response time corresponding to the region R(i). That is, if the processing time or response time of the storage device 12 for the read command is longer, it indicates that the storage device response time corresponding to the region R(i) is also longer. Next, the host system 11 may obtain the response time information corresponding to the region R(i) according to the storage device response time corresponding to the region R(i). For instance, the response time information corresponding to the region R(i) may reflect the storage device response time corresponding to the region R(i).

In an embodiment, the host system 11 may evaluate a degree of data fragmentation corresponding to the region R(i) according to the response time information corresponding to the region R(i). For instance, the storage device response time corresponding to the region R(i) may be positively correlated with the degree of data fragmentation corresponding to the region R(i). That is, if the storage device response time corresponding to the region R(i) is longer, the host system 11 may determine that the degree of data fragmentation corresponding to the region R(i) is higher. In addition, the degree of data fragmentation corresponding to the region R(i) may be positively correlated with a degree of dispersion of data belonging to the region R(i) in the memory module 122. That is, if the degree of data fragmentation corresponding to the region R(i) is higher, it indicates that the degree of dispersion of the data belonging to the region R(i) in the memory module 122 is higher (i.e., the data fragmentation is more severe).

In an embodiment, the host system 11 may obtain a fragmentation evaluation value corresponding to the region R(i) according to the response time information corresponding to the region R(i). For instance, the storage device response time corresponding to the region R(i) may be positively correlated with the fragmentation evaluation value. In addition, this fragmentation evaluation value may reflect the degree of data fragmentation corresponding to the region R(i). For instance, this fragmentation evaluation value may be positively correlated with the degree of data fragmentation corresponding to the region R(i).

In an embodiment, when the host system 11 sends a read command to the storage device 12 to instruct accessing a logical unit located in region R(i) (e.g., reading data from this logical unit), the host system 11 may determine unit response time corresponding to the region R(i) according to the monitored storage device response time corresponding to the region R(i) and a read data length corresponding to the read command. For instance, the read data length may reflect a data length of the data indicated to be read by the read command.

In an embodiment, the host system 11 may divide the monitored storage device response time (ΔT) corresponding to the region R(i) by the read data length (ΔS) corresponding to the read command to obtain the unit response time (UT) corresponding to the region R(i). That is, UT=ΔT/ΔS. Next, the host system 11 may obtain the fragmentation evaluation value corresponding to the region R(i) according to the unit response time.

In an embodiment, the unit response time corresponding to the region R(i) may be positively correlated with the fragmentation evaluation value corresponding to the region R(i). That is, if the unit response time corresponding to the region R(i) is longer, the fragmentation evaluation value corresponding to the region R(i) may be larger. In an embodiment, the host system 11 may input the unit response time into a predetermined algorithm or perform a table lookup to obtain the fragmentation evaluation value corresponding to the region R(i).

In an embodiment, the host system 11 may determine whether the unit response time corresponding to the region R(i) is greater than an average response time. If the unit response time corresponding to the region R(i) is greater than the average response time, the host system 11 may add an adjustment value (e.g., “1”) to the fragmentation evaluation value corresponding to the region R(i) to update the fragmentation evaluation value corresponding to the region R(i). However, if the unit response time corresponding to the region R(i) is not greater than the average response time, the host system 11 may not add the adjustment value to the fragmentation evaluation value corresponding to the region R(i) (i.e., the fragmentation evaluation value corresponding to the region R(i) is not updated).

In an embodiment, the host system 11 may obtain the average response time according to the unit response time corresponding to each of the regions R(1) to R(y). That is, the average response time may reflect the average value of the unit response time corresponding to each of the regions R(1) to R(y).

In an embodiment, after instructing the storage device 12 to perform defragmentation on the data belonging to region R(i), the host system 11 may reset the fragmentation evaluation value corresponding to the region R(i). For instance, the host system 11 may reset the fragmentation evaluation value corresponding to the region R(i) to an initial value (e.g., “0”).

In an embodiment, after determining region R(i) as a candidate logical region, the host system 11 may determine whether the fragmentation evaluation value corresponding to the region R(i) is greater than a predetermined value. If the fragmentation evaluation value corresponding to the region R(i) is greater than the predetermined value, the host system 11 may determine region R(i) as a target logical region. However, if the fragmentation evaluation value corresponding to the region R(i) is not greater than (e.g., less than or equal to) the predetermined value, the host system 11 may not determine region R(i) as a target logical region.

In an embodiment, after determining the target logical region, the host system 11 may instruct the storage device 12 to perform defragmentation on the data belonging to the target logical region (also referred to as target data). For instance, the target data may be valid data. Alternatively, the target data may not include invalid data. For instance, the host system 11 sends a specially-designed developer command or other operation command to the storage device 12 to instruct the storage device 12 to perform defragmentation on the data belonging to the target logical region.

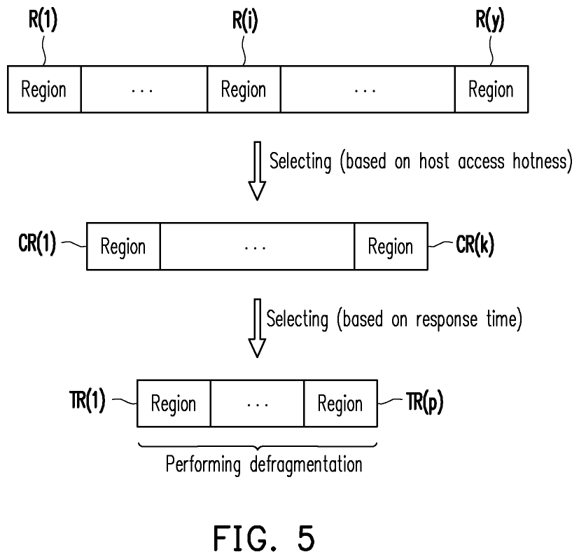

FIG. 5 is a schematic view illustrating determination a target logical region based on host access hotness and storage device response time according to an embodiment of the disclosure. Referring to FIG. 5, continuing from the embodiments of FIG. 4, the host system 11 may select a plurality of regions CR(1) to CR(k) with relatively higher host access hotness from the regions R(1) to R(y) as candidate logical regions according to the access hotness information. Next, the host system 11 may further select regions TR(1) to TR(p) with relatively longer storage device response time (equivalent to relatively higher degree of data fragmentation) among the regions CR(1) to CR(k) (i.e., candidate logical regions) as target logical regions according to response time information. After the target logical regions are determined, the host system 11 may instruct the storage device 12 to perform defragmentation on the data (i.e., target data) belonging to the regions TR(1) to TR(p) (i.e., target logical regions).

In an embodiment, in the operation of performing the defragmentation on the target data belonging to the target logical region, the memory control circuit 23 may centrally store the data with a degree of fragmentation higher than a predetermined degree (i.e., the target data) into at least one physical unit (also referred to as a target physical unit) in the memory module 122. For instance, assuming that the target logical region includes the region R(i), the memory control circuit 23 may query logical-to-physical mapping information corresponding to the region R(i), so as to determine a plurality of physical units (also referred to as reference physical units) mapped by the logical units located in the region R(i). The memory control circuit 23 may dispersedly read data (i.e., target data) from the reference physical units and then centrally store the read target data into the target physical unit in the memory module 122. In this way, a beneficial technical effect may be achieved in which the host system 11 initiates the adjustment of the target data, which was dispersedly stored previously in the memory module 122 (i.e., the reference physical units) mostly in fragmented form, to be stored in the memory module 122 in a central storage form that supports sequential access (e.g., sequential reading). In this way, the access efficiency of the host system 11 and the storage device 12 for the target data is improved in the future.

In an embodiment, the memory control circuit 23 may further determine the total number of free physical units in the memory module 122. For instance, the free physical units do not store valid data. In an embodiment, the memory control circuit 23 may determine whether the total number of the free physical units is less than a threshold value. For instance, the threshold value may be 10, 15, or other values.

In an embodiment, the memory control circuit 23 (or the storage device 12) performs the aforementioned defragmentation on the target data belonging to the target logical region based on the instruction of the host system 11 only when the total number of the free physical units is not less than (e.g., greater than or equal to) the threshold value. For instance, when the total number of the free physical units is still relatively sufficient (i.e., the total number of the free physical units is not less than the threshold value), the memory control circuit 23 may perform the aforementioned defragmentation on the target data belonging to the target logical region based on the instruction of the host system 11, so as to improve the operational efficiency of the storage device 12 in the future through an optimized data defragmentation mechanism.

However, in an embodiment, if the total number of the free physical units is less than the threshold value, it indicates that new free physical units need to be urgently released at present. The memory control circuit 23 may then determine which physical erase units (e.g., physical erase units storing relatively less valid data) to perform the aforementioned defragmentation on according to the amount of valid data stored in each physical erase unit. In this way, when new free physical units need to be urgently released, new free physical units may be released at a relatively faster speed.

In an embodiment, the aforementioned defragmentation may be treated as one type of various data organization operations. In an embodiment, during the defragmentation performed on the target data belonging to the target logical region, the memory control circuit 23 may further synchronously perform a garbage collection (GC) operation, a wear leveling (WL) operation, or other types of data organization operations on the target data, so as to further improve the operational efficiency of the storage device 12 in the future, and description thereof is not repeated one by one herein.

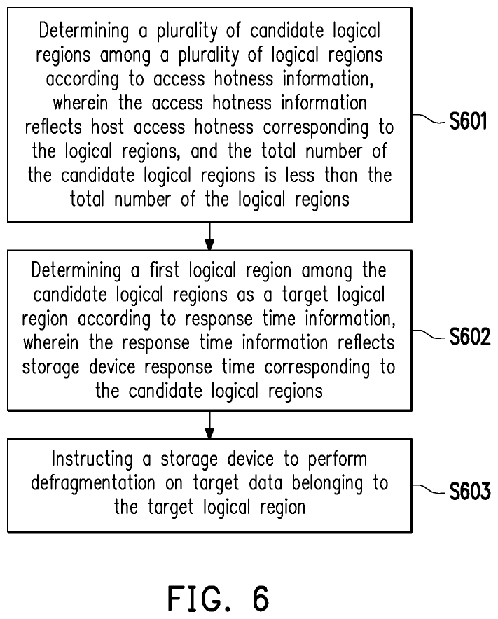

FIG. 6 is a flow chart illustrating a data defragmentation method according to an embodiment of the disclosure. Referring to FIG. 6, in step S601, according to access hotness information, a plurality of candidate logical regions among a plurality of logical regions are determined. The access hotness information reflects host access hotness corresponding to the logical regions, and the total number of the candidate logical regions is less than the total number of the logical regions. After the candidate logical regions are determined, a first logical region among the candidate logical regions is determined as a target logical region according to response time information. The response time information reflects storage device response time corresponding to the candidate logical regions. In step S603, the storage device is instructed to perform defragmentation on target data belonging to the target logical region.

Each step of FIG. 6 has been described in detail in the foregoing paragraphs, and description thereof is thus not repeated herein. It should be noted that each step in FIG. 6 may be implemented as a plurality of program codes or circuits, which is not particularly limited by the disclosure. In addition, the method of FIG. 6 may be used in combination with the above-described exemplary embodiments or may be used solely, which is not particularly limited by the disclosure.

In view of the foregoing, the data defragmentation method and the data storage system provided in the embodiments of the disclosure may be initiated by the host system. The target logical region is determined based on the host access hotness and the storage device response time corresponding to the logical regions, and then the storage device is instructed to perform defragmentation on the target data belonging to the target logical region. Compared to the conventional approach in which the storage device itself may simply select the physical blocks that need to perform defragmentation by referencing the amount of valid data, the data defragmentation method and the data storage system provided in the embodiments of the disclosure may preferentially perform defragmentation on the data with both higher host access hotness and longer storage device response time. In this way, the operational efficiency of the storage device is improved.

Finally, it is worth noting that the foregoing embodiments are merely described to illustrate the technical means of the disclosure and should not be construed as limitations of the disclosure. Even though the foregoing embodiments are referenced to provide detailed description of the disclosure, people having ordinary skill in the art should understand that various modifications and variations can be made to the technical means in the disclosed embodiments, or equivalent replacements may be made for part or all of the technical features; nevertheless, it is intended that the modifications, variations, and replacements shall not make the nature of the technical means to depart from the scope of the technical means of the embodiments of the disclosure.

What is claimed is:

1. A data defragmentation method for a host system connected to a storage device comprising a memory module, and the data defragmentation method comprising:
determining a plurality of candidate logical regions among a plurality of logical regions according to access hotness information, wherein the access hotness information reflects host access hotness corresponding to the logical regions, and the total number of the candidate logical regions is less than the total number of the logical regions;
determining a first logical region among the candidate logical regions as a target logical region according to response time information after determining the candidate logical regions, wherein the response time information reflects storage device response time corresponding to the candidate logical regions; and
instructing the storage device to perform defragmentation on target data belonging to the target logical region.

2. The data defragmentation method according to claim 1, wherein the host access hotness corresponding to each logical region among the candidate logical regions is higher than the host access hotness corresponding to each of the remaining logical regions among the logical regions that do not belong to the candidate logical regions.

3. The data defragmentation method according to claim 1, wherein the access hotness information comprises first access hotness information reflecting first host access hotness corresponding to the first logical region, and the data defragmentation method further comprises:
obtaining first count information reflecting the first number of host accesses to the first logical region within a first time frame;
obtaining second count information reflecting the second number of host accesses to the first logical region within a second time frame, wherein the first time frame is different from the second time frame; and
obtaining the first access hotness information according to the first count information and the second count information.

4. The data defragmentation method according to claim 1, wherein the response time information comprises first response time information reflecting a first storage device response time corresponding to the first logical region, and the step of determining the first logical region among the candidate logical regions as the target logical region according to the response time information comprises:
obtaining a first fragmentation evaluation value according to the first storage device response time, wherein the first fragmentation evaluation value reflects a first degree of data fragmentation corresponding to the first logical region; and
determining the first logical region as the target logical region according to the first fragmentation evaluation value.

5. The data defragmentation method according to claim 4, wherein the step of obtaining the first fragmentation evaluation value according to the first storage device response time comprises:
determining unit response time corresponding to the first logical region according to the first storage device response time and a read data length corresponding to a read command; and
obtaining the first fragmentation evaluation value according to the unit response time.

6. The data defragmentation method according to claim 5, wherein the step of obtaining the first fragmentation evaluation value according to the unit response time comprises:
adding an adjustment value to the first fragmentation evaluation value to update the first fragmentation evaluation value if the unit response time is greater than average response time; and
resetting the first fragmentation evaluation value after performing the defragmentation on data belonging to the first logical region.

7. The data defragmentation method according to claim 4, wherein the step of determining the first logical region as the target logical region according to the first fragmentation evaluation value comprises:
determining the first logical region as the target logical region in response to the first fragmentation evaluation value being greater than a predetermined value.

8. The data defragmentation method according to claim 1, wherein the storage device performs the defragmentation on the target data belonging to the target logical region based on an instruction of the host system only when the total number of free physical units in the memory module is not less than a threshold value, wherein the free physical units do not store valid data.

9. The data defragmentation method according to claim 1, wherein in the operation of performing the defragmentation on the target data belonging to the target logical region, the storage device centrally stores the target data having a fragmentation degree higher than a predetermined degree into a target physical unit in the memory module.

10. A data storage system, comprising:
a storage device; and
a host system connected to the storage device,
wherein the storage device comprises a memory module, and the host system is configured to:
determine a plurality of candidate logical regions among a plurality of logical regions according to access hotness information, wherein the access hotness information reflects host access hotness corresponding to the logical regions, and the total number of the candidate logical regions is less than the total number of the logical regions,
determine a first logical region among the candidate logical regions as a target logical region according to response time information after determining the candidate logical regions, wherein the response time information reflects storage device response time corresponding to the candidate logical regions, and
instruct the storage device to perform defragmentation on target data belonging to the target logical region.

11. The data storage system according to claim 10, wherein the host access hotness corresponding to each logical region among the candidate logical regions is higher than the host access hotness corresponding to each of the remaining logical regions among the logical regions that do not belong to the candidate logical regions.

12. The data storage system according to claim 10, wherein the access hotness information comprises first access hotness information reflecting first host access hotness corresponding to the first logical region, and the host system is further configured to:
obtain first count information reflecting the first number of host accesses to the first logical region within a first time frame,
obtain second count information reflecting the second number of host accesses to the first logical region within a second time frame, wherein the first time frame is different from the second time frame, and
obtain the first access hotness information according to the first count information and the second count information.

13. The data storage system according to claim 10, wherein the response time information comprises first response time information reflecting a first storage device response time corresponding to the first logical region, and the operation of the host system determining the first logical region among the candidate logical regions as the target logical region according to the response time information comprises:
obtain a first fragmentation evaluation value according to the first storage device response time, wherein the first fragmentation evaluation value reflects a first degree of data fragmentation corresponding to the first logical region, and
determine the first logical region as the target logical region according to the first fragmentation evaluation value.

14. The data storage system according to claim 13, wherein the operation of the host system obtaining the first fragmentation evaluation value according to the first storage device response time comprises:
determine unit response time corresponding to the first logical region according to the first storage device response time and a read data length corresponding to a read command, and
obtain the first fragmentation evaluation value according to the unit response time.

15. The data storage system according to claim 14, wherein the operation of the host system obtaining the first fragmentation evaluation value according to the unit response time comprises:
add an adjustment value to the first fragmentation evaluation value to update the first fragmentation evaluation value if the unit response time is greater than average response time, and
reset the first fragmentation evaluation value after performing the defragmentation on data belonging to the first logical region.

16. The data storage system according to claim 15, wherein the operation of the host system determining the first logical region as the target logical region according to the first fragmentation evaluation value comprises:
determine the first logical region as the target logical region in response to the first fragmentation evaluation value being greater than a predetermined value.

17. The data storage system according to claim 10, wherein the storage device performs the defragmentation on the target data belonging to the target logical region based on an instruction of the host system only when the total number of free physical units in the memory module is not less than a threshold value, wherein the free physical units do not store valid data.

18. The data storage system according to claim 10, wherein in the operation of performing the defragmentation on the target data belonging to the target logical region, the storage device centrally stores the target data having a fragmentation degree higher than a predetermined degree into a target physical unit in the memory module.
